(19) United States
(12) Patent Application Publication
(10) Pub. No.: US 2025/0026256 A1
(43) Pub. Date: Jan. 23, 2025

(54) VEHICLE FLOOR MAT STRUCTURE

(71) Applicant: SUBARU CORPORATION, Tokyo (JP)

(72) Inventor: Riku HASEGAWA, Tokyo (JP)

(21) Appl. No.: 18/738,793

(22) Filed: Jun. 10, 2024

(30) Foreign Application Priority Data
Jul. 18, 2023 (JP) 2023-116856

(51) Int. Cl. B60N 3/04

(52) U.S. Cl. CPC B60N 3/048

(57) ABSTRACT

A vehicle floor mat structure configured to guide air-conditioned air blown from below a front seat of a vehicle toward a foot of a passenger seated on a rear seat of the vehicle. The vehicle floor mat structure includes an opening and an inclined portion. The opening is provided in a floor mat below the front seat and serves as an air passage for the air-conditioned air. The inclined portion is provided closer to the rear seat than the opening is to the rear seat. The inclined portion is provided on the floor mat. The inclined portion includes an upward inclined surface toward the rear seat.

### CROSS-REFERENCE TO RELATED APPLICATIONS

The present application claims priority from Japanese Patent Application No. 2023-116856 filed on Jul. 18, 2023, the entire contents of which are hereby incorporated by reference.

### BACKGROUND

The disclosure relates to a vehicle floor mat structure.

As a structure for disposing an air conditioning duct in the related art, for example, a structure described in Japanese Unexamined Patent Application Publication (JP-A) No. 2009-67227 is known.

As a structure for disposing an air conditioning duct in the related art, for example, a structure described in JP-A No. 2005-289282 is known.

### SUMMARY

An aspect of the disclosure provides a vehicle floor mat structure configured to guide air-conditioned air blown from below a front seat of a vehicle toward a foot of a passenger seated on a rear seat of the vehicle. The vehicle floor mat structure includes an opening and an inclined portion. The opening is provided in a floor mat below the front seat and serves as an air passage for the air-conditioned air. The inclined portion is provided closer to the rear seat than the opening is to the rear seat. The inclined portion is provided on the floor mat. The inclined portion includes an upward inclined surface toward the rear seat.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a cross-sectional view illustrating a vehicle having a vehicle floor mat structure according to an embodiment of the disclosure.

FIG. 2 is a plan view illustrating the vehicle floor mat structure according to the embodiment of the disclosure.

FIG. 3 is a cross-sectional view illustrating the vehicle floor mat structure according to the embodiment of the disclosure.

FIG. 4A is a schematic view illustrating air conditioning performance in the vehicle floor mat structure according to the embodiment of the disclosure.

FIG. 4B is a schematic view illustrating air conditioning performance in the vehicle floor mat structure according to the embodiment of the disclosure.

### DETAILED DESCRIPTION

In JP-A No. 2009-67227, on a driver's seat side of a vehicle, a pair of slide rails are disposed on an upper surface of a front floor and extend in a front-rear direction of the vehicle along a floor tunnel. A front seat is slidably disposed in the front-rear direction of the vehicle via the slide rails. An installation space for installing the slide rails or the like is provided between a seat cushion of the front seat and the front floor.

An air conditioning duct for blowing air-conditioned air to a passenger seated on a rear seat is routed from a front panel on a front side of the front seat. The air conditioning duct extends along the floor tunnel into the installation space below the front seat. A blowing port at a tip end of the air conditioning duct is inside the installation space and is opened toward the rear seat.

In JP-A No. 2005-289282, an air conditioning unit includes a rear duct extending in a front-rear direction of a floor panel. The rear duct includes an air distribution duct extending in a vehicle width direction between the front seat and the rear seat. The blowing port for blowing the air-conditioned air to a foot of the passenger seated on the rear seat is provided in an intermediate portion of the air distribution duct.

In the structure for disposing the air conditioning duct described in JP-A No. 2009-67227, the air-conditioned air is blown from below the front seat toward the rear seat via the installation space. However, since the installation space is a recessed space on the front floor, there is a problem that the air-conditioned air is blocked by a wall of a floor mat in the installation space and is less likely to be blown toward the rear seat.

In the structure for disposing the air conditioning duct described in JP-A No. 2005-289282, the air conditioning unit is disposed inside the instrument panel, and the rear duct extends to a rear side of the front seat. With this structure, the number of components increases, which is caused by an increase in a length of the air conditioning duct or the like, and thus there is a problem that manufacturing costs increase. Since the air distribution duct is exposed at the foot of the passenger seated on the rear seat, and a step is formed by the air distribution duct, there is a problem that comfort of the passenger is impaired, such as narrowing of a foot space.

It is desirable to provide a vehicle floor mat structure that improves comfort at a foot of a passenger seated on a rear seat by forming an opening for blowing air-conditioned air and an inclined portion that guides the air-conditioned air toward the rear seat on a floor mat below a front seat.

Hereinafter, a vehicle floor mat structure 10 according to an embodiment of the disclosure will be described in detail based on the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. A front-rear direction illustrated on the paper indicates a total length direction of a vehicle 11, a left-right direction on the paper indicates a vehicle width direction of the vehicle 11, and an upper-lower direction on the paper indicates a height direction of the vehicle 11.

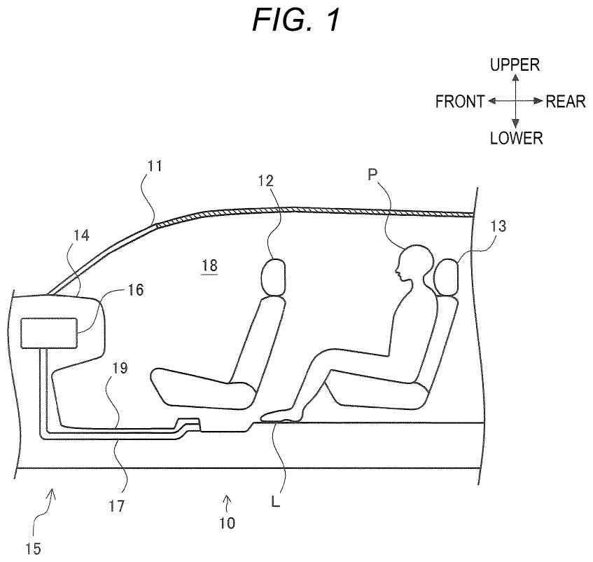

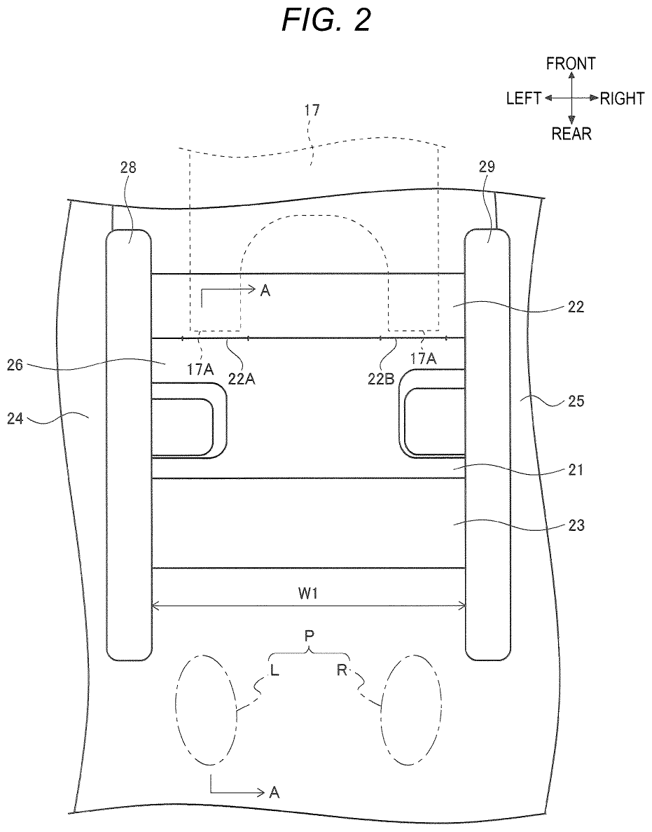

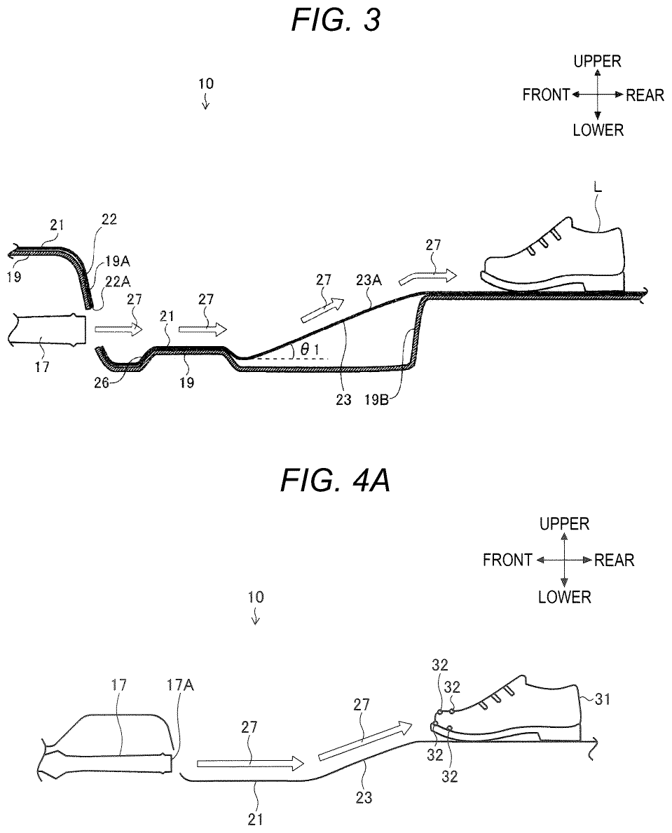

FIG. 1 is a cross-sectional view illustrating the vehicle 11 in which the vehicle floor mat structure 10 is disposed according to the present embodiment. FIG. 2 is a plan view illustrating the vehicle floor mat structure 10 according to the present embodiment. FIG. 3 is a cross-sectional view illustrating the vehicle floor mat structure 10 according to the present embodiment, and illustrates a cross-section taken in an A-A line direction illustrated in FIG. 2.

As illustrated in FIG. 1, for example, a battery electrical vehicle (BEV), a hybrid electrical vehicle (HEV), a plug-in hybrid electrical vehicle (PHEV), or the like is adopted as the vehicle 11. The vehicle 11 is not limited to the electric vehicle described above, and also includes the vehicle 11 which travels based on an internal combustion engine using gasoline or the like as fuel.

The vehicle 11 includes a front seat 12 and a rear seat 13. The front seat 12 includes a driver's seat or a front passenger's seat on a front side of the vehicle 11. The rear seat 13 is disposed behind the front seat 12. An air conditioner 15 is assembled into an instrument panel 14 of the vehicle 11. The air conditioner 15 includes an air conditioning unit 16 and an air conditioning duct 17 coupled to the air conditioning unit 16.

The air conditioning unit 16 includes a blower, a cooling unit, a heater, and the like that are not illustrated. The air conditioning unit 16 suctions air in a vehicle cabin 18 or outside air from outside the vehicle, and adjusts a temperature of air-conditioned air to be blown into the vehicle cabin 18. The air-conditioned air is blown into the vehicle cabin 18 via the air conditioning duct 17, so that a temperature inside the vehicle cabin 18 is adjusted to a comfortable temperature for a passenger.

As illustrated in FIG. 2, the air conditioning duct 17 extends below a floor panel 19 of the vehicle 11 and is routed below the front seat 12 toward feet R and L of a passenger P seated on the rear seat 13 of the vehicle 11. Then, the air-conditioned air is blown toward the rear seat 13 below the front seat 12 via the air conditioning duct 17 and openings 22A and 22B (see FIG. 2), so that the feet R and L of the passenger P seated on the rear seat 13 are adjusted to a comfortable temperature.

FIG. 2 illustrates a shape of a floor mat 21 below the front seat 12. For convenience of description, the front seat 12 is not illustrated.

As illustrated in FIG. 2, the floor mat 21 covers an upper surface of the floor panel 19 (see FIG. 1). The floor mat 21 on the front side of the front seat 12 has a protrusion 22 for securing a foot space for an occupant (not illustrated) seated on the front seat 12. An inclined portion 23 extending toward the rear seat 13 is provided behind the protrusion 22. A pair of seat rail protrusions 24 and 25 are provided on both sides of the protrusion 22 and the inclined portion 23 in the vehicle width direction. With this structure, a recess 26 surrounded by the protrusion 22, the inclined portion 23, and the seat rail protrusions 24 and 25 are provided in the floor mat 21. A pair of seat rails 28 and 29 that slidably support the front seat 12 are disposed above the seat rail protrusions 24 and 25.

The two openings 22A and 22B are provided on the rear seat 13 side of the protrusion 22 so as to be opened toward the inclined portion 23. The openings 22A and 22B are also provided in the floor panel 19 inside the floor mat 21. The air conditioning duct 17 extends to the vicinity of the openings 22A and 22B, and blowing ports 17A are provided at tip ends of the air conditioning duct 17.

With this structure, the air-conditioned air, which has a temperature adjusted by the air conditioning unit 16 and is blown from the blowing ports 17A, is blown toward the rear seat 13 via the openings 22A and 22B. As will be described in detail later, after being blown into a space of the recess 26, the air-conditioned air flows toward the rear seat 13 along an inclined surface 23A (see FIG. 3) of the inclined portion 23, and is guided to the feet R and L of the passenger P seated on the rear seat 13 and surrounding regions of the feet R and L.

As illustrated in FIG. 3, the floor panel 19 below the front seat 12 has a wall 19A in a substantially vertical state in a region where the protrusion 22 is provided, and also has a wall 19B in a substantially vertical state in a region where the inclined portion 23 is provided. The floor mat 21 is disposed along the upper surface of the floor panel 19 in a partial region of the protrusion 22 and a partial region of the recess 26 on the protrusion 22 side.

On the other hand, the floor mat 21 has the upward inclined surface 23A toward the rear seat 13 in the region where the inclined portion 23 is provided. The floor mat 21 is provided in a state of being separated from the floor panel 19. As described above, since the floor mat 21 is provided by press molding, an inclined shape described above can be maintained independently.

With this structure, as indicated by arrows 27, the air-conditioned air blown from the openings 22A and 22B toward the rear seat 13 flows in the space of the recess 26 toward the rear seat 13, and is then blown toward the rear seat 13 along the inclined surface 23A of the inclined portion 23. As illustrated in FIG. 2, the inclined surface 23A is provided between the pair of seat rail protrusions 24 and 25, so that the air-conditioned air does not excessively spread in the vehicle width direction and is blown toward the rear seat 13 in a substantially linear manner.

As a result, both feet R and L of the passenger P seated on the rear seat 13 immediately behind the front seat 12 are normally within a width W1 (see FIG. 2) in the region where the inclined portion 23 is provided, and are placed around the pair of seat rail protrusions 24 and 25. The air-conditioned air blown from below the front seat 12 toward the rear seat 13 is guided to the vicinity of the feet R and L of the passenger P, so that a riding environment or an air conditioning environment that is comfortable for the passenger P is implemented.

As illustrated in FIG. 3, the inclined portion 23 of the floor mat 21 is disposed below the front seat 12 and is provided in a region that is not stepped on by a foot of the passenger P.

Therefore, it is sufficient for the inclined portion 23 to have rigidity capable of maintaining a shape thereof even when the inclined portion 23 collides with the air-conditioned air, and there is no problem even when the floor mat 21 is separated from the floor panel 19.

With this structure, an angle θ1 of the inclined surface 23A of the floor mat 21 can be easily adjusted by press molding according to the space of the recess 26 or the like below the front seat 12. For example, when a wide space of the recess 26 can be secured, the angle θ1 of the inclined surface 23A is designed to be small, so that the air-conditioned air is less likely to collide with the inclined surface 23A and to be distributed or is less likely to flow backward, and the following air conditioning characteristics are improved.

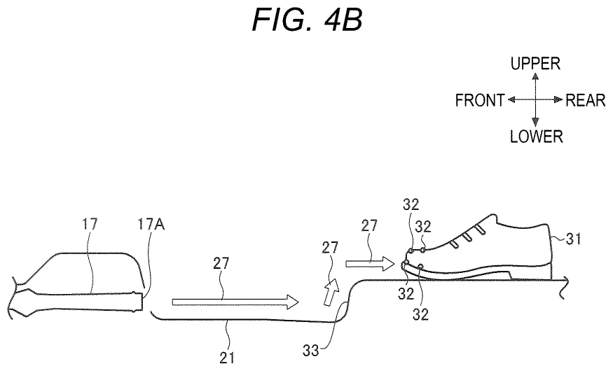

Herein, with reference to FIGS. 4A and 4B, the air conditioning performance of the air-conditioned air when the vehicle floor mat structure 10 according to the present embodiment is provided and that when the vehicle floor mat structure 10 according to the present embodiment is not provided will be described.

FIG. 4A is a schematic view illustrating a test situation when the inclined portion 23 is provided in the vehicle floor mat structure 10 according to the present embodiment. As a comparative example of FIG. 4A, FIG. 4B is a schematic view illustrating a test situation when the inclined portion 23 is not provided in the vehicle floor mat structure 10 according to the present embodiment. In the tests, anemometers 32 are provided at tip ends of a shoe 31, and air volume and the temperature of the air-conditioned air blown from the air conditioner 15 are set to the same conditions.

In a structure including the inclined portion 23 illustrated in FIG. 4A, the inclined portion 23 has a length approximately half the linear length from the blowing ports 17A of the air conditioning duct 17 to the tip end of the shoe 31. On the other hand, in a structure not including the inclined portion 23 illustrated in FIG. 4B, a wall 33 having a substantially vertical shape is provided in an intermediate portion of the inclined portion 23 illustrated in FIG. 4A. The blowing ports 17A of the air conditioning duct 17 in FIG. 4A has the same height position as that in FIG. 4B has. The anemometers 32 at the tip ends of the shoe 31 in FIG. 4A has the same height position as that in FIG. 4B has.

As a result of the above-described test, in the structure including the inclined portion 23 illustrated in FIG. 4A, a wind speed of 1.1 m/s was measured by the anemometers 32 for the air-conditioned air blown from the blowing ports 17A of the air conditioning duct 17 at a wind speed of 1.5 m/s. This is because, when the air-conditioned air flows along the inclined portion 23, most of the air-conditioned air reaches the shoe 31 without being distributed by the inclined portion 23. On the other hand, in the structure not including the inclined portion 23 illustrated in FIG. 4B, a wind speed of 0.7 m/s was measured by the anemometers 32 for the air-conditioned air blown from the blowing ports 17A of the air conditioning duct 17 at a wind speed of 1.5 m/s. This is because a part of the air-conditioned air flows backward to the blowing ports 17A due to the wall 33, momentum of flows of the air-conditioned air is canceled, and turbulence or the like occurs around the wall 33. Thus, a part of the air-conditioned air is distributed and does not reach the shoe 31.

As a result, the structure including the inclined portion 23 illustrated in FIG. 4A exhibits an improvement in the air conditioning performance of approximately 57% as compared with the structure not including the inclined portion 23 illustrated in FIG. 4B.

In the present embodiment, a case has been described where the blowing ports 17A of the air conditioning duct 17 are disposed inside the floor mat 21 without routing the air conditioning duct 17 into the vehicle cabin 18 from the openings 22A and 22B of the floor mat 21, and the disclosure is not limited thereto. For example, the air conditioning duct 17 may be routed out of the vehicle cabin 18 via the openings 22A and 22B, and the blowing ports 17A of the air conditioning duct 17 may be disposed outside the floor mat 21. In this case, the air-conditioned air does not flow directly through the openings 22A and 22B, but the air conditioning duct 17 is disposed inside the openings 22A and 22B, so that the openings 22A and 22B are construed to be a part of an air passage of the air-conditioned air.

As illustrated in FIG. 2, a case has been described where the inclined portion 23 and the inclined surface 23A thereof are provided over the width W1 between the seat rails 28 and 29, but the disclosure is not limited thereto. For example, since the air-conditioned air blown from the blowing ports 17A of the air conditioning duct 17 normally flows linearly toward the rear seat 13 of the vehicle 11, the inclined portion 23 and the inclined surface 23A thereof are disposed at least in a region facing the opening 22A in the vehicle width direction of the vehicle 11, so that the above-described effects can be attained. Various other modifications may be made without departing from the gist of the disclosure.

The vehicle floor mat structure according to an embodiment of the disclosure includes an opening provided in a floor mat below a front seat and serving as an air passage for air-conditioned air, and an inclined portion provided closer to a rear seat than the opening is to the rear seat. With this structure, the air-conditioned air blown from below the front seat efficiently flows toward the rear seat via the inclined portion. The air-conditioned air is guided to a foot of a passenger seated on the rear seat, so that a riding environment or an air conditioning environment that is comfortable for the passenger is implemented.

1. A vehicle floor mat structure configured to guide air-conditioned air blown from below a front seat of a vehicle toward a foot of a passenger seated on a rear seat of the vehicle, the vehicle floor mat structure comprising:
an opening provided in a floor mat below the front seat, the opening serving as an air passage for the air-conditioned air; and
an inclined portion provided closer to the rear seat than the opening is to the rear seat, the inclined portion being provided on the floor mat, wherein
the inclined portion comprises an upward inclined surface toward the rear seat.

2. The vehicle floor mat structure according to claim 1, wherein the inclined portion is provided between seat rails in a pair, the seat rails being configured to support the front seat.

3. The vehicle floor mat structure according to claim 2, wherein
at least a part of the inclined portion is located below the front seat, and
the floor mat on which the inclined portion is provided is separated from a floor panel of the vehicle.

4. The vehicle floor mat structure according to claim 2, wherein
the opening is opened toward the inclined portion, and
a blowing port of an air conditioning duct is disposed below the floor mat in the vicinity of the opening.

5. The vehicle floor mat structure according to claim 3, wherein
the opening is opened toward the inclined portion, and
a blowing port of an air conditioning duct is disposed below the floor mat in the vicinity of the opening.
